(19) United States
(12) Patent Application Publication
(10) Pub. No.: US 2020/0306015 A1
(43) Pub. Date: Oct. 1, 2020

(54) IMPLANT DEVICE

(71) Applicants: TAIWAN SHAN YIN INTERNATIONAL CO., LTD., KAOHSIUNG CITY (TW); BIOMATE MEDICAL DEVICES TECHNOLOGY CO., LTD., KAOHSIUNG CITY (TW)

(72) Inventors: KOU-TSAIR SU, KAOHSIUNG CITY (TW); YU-JUNG SU, KAOHSIUNG CITY (TW)

(21) Appl. No.: 16/902,870

(22) Filed: Jun. 16, 2020

Related U.S. Application Data
(63) Continuation-in-part of application No. 16/002,335, filed on Jun. 7, 2018.

(51) Int. Cl. A61C 8/00

(52) U.S. Cl. CPC A61C 8/0074; A61C 8/0054

(57) ABSTRACT

An implant device includes an implant with a threaded portion and a drilling portion and a positioning hole respectively formed at two ends of the implant. Channels are recessedly formed on an outer surface of the implant. Each channel includes pore units joined one another in a row. An interior of each pore unit includes a first area enclosed by a peripheral wall and a second area defined between adjacent surface portions and communicating with the first area. The peripheral wall has first projecting units formed thereon to present a surface with concavities and convexities. Second projecting units extend outwards from adjacent peripheral walls and overlap one another between every two adjacent channels to define each surface portion. Cells derived from a target part are quickly attached to the channels and linked with each other for enhancing the combination between the implant and the target part.

### CROSS-REFERENCE TO RELATED APPLICATION

This invention is a continuation-in-part of the U.S. patent application Ser. No. 16/002,335, filed on 7 Jun. 2018, of which the subject matter is incorporated herein by reference in its entirety.

### BACKGROUND OF THIS INVENTION

### 1. Field of this Invention

This invention relates to an implant device and relates particularly to an implant which benefits the proliferation of cells and speeds up the process of healing the implanted part.

### 2. Description of the Related Art

An implant device is widely applied. Particularly, it is commonly used in the dental field and orthopedics, and herein the implant device applied to the dental implantology is taken as an example. It is known to fix a metal implant to the alveolar bone in the oral cavity for treating missing or broken teeth. After the implant is implanted into the alveolar bone, bone cells derived from the bone need to combine with the implant to attain an osseointegration effect. Generally, the implant has a porous structure whereby the cells are attached to the implant. However, traditional pore units are usually spaced apart at different distances and are different in size and depth. This traditional design takes lots of time to complete the osseointegration because reborn cells of the alveolar bone are too small to climb between the pore units and it takes the cells lots of time to grow and increase in size. The bone cells cannot climb between the adjacent pore units until they grow up to have a size sufficient to climb between the pore units and link. This causes a long period of osseointegration and thus the bone tissue requires a long convalescence period. Therefore, the traditional design needs improvement.

### SUMMARY OF THIS INVENTION

An object of this invention is to provide an implant device which allows cells to be quickly and smoothly attached to the implant, and promotes the growth of cells, thereby attaining a stable combination between the implant and the target part and shortening the convalescence period of the tissue of the target part.

An implant device of this invention includes an implant with a threaded portion and includes a drilling portion and a positioning hole respectively formed at two ends of the implant. A multiplicity of rows of communicating pore units defines a plurality of channels. The channels are recessedly formed on an outer surface of the implant, and the outer surface includes at least a shank surface disposed between axially spaced-apart adjacent threads of the threaded portion. Each channel includes a plurality of pore units jointed to each other, and an interior of the pore units are in open communication with one another in a row to thereby define each channel. The interior of the pore unit includes a first area and a second area communicating with the first area. Each pore unit has a peripheral wall extending toward an interior of the implant and forming a closed bottom portion and a plurality of second projecting units extending outwards from the peripheral wall. The first area is enclosed by the peripheral wall, and the extension of the peripheral wall defines a first depth which is not more than 10 nm. The first depth is perpendicular to a first horizontal line passing the bottom portion. The peripheral walls of the pore units are joined on another in a row to thereby define each channel. The peripheral wall has a plurality of first projecting units formed thereon so that the peripheral wall is formed in a surface with concavities and convexities and also defines a first hole diameter within the first area. The first hole diameter decreases gradually towards the bottom portion and is not more than 10 μm. The second projecting units extend in a direction opposite to the bottom portion and overlap one another between every two adjacent channels to thereby define a surface portion with a crest. The second area is defined between every two adjacent surface portions. Each surface portion is asymmetric. A maximum width defined between two junctions where each surface portion meets the peripheral walls of the adjacent channels is larger than a maximum width of the crest of the surface portion. A space of not more than 30 μm is defined between the adjacent surface portions and increases gradually toward the crest. Two second horizontal lines are respectively defined by passing the crests of the adjacent surface portions. Two vertical distances each are defined between the corresponding second horizontal lines and the first horizontal line, and the difference of the two vertical distances is not more than Sum. Accordingly, when the implant device is fastened to a target part, reborn cells of the target part grip the uneven surface portions easily, enter each channel caused by the communicating pore units, and grip the first projecting units of the uneven peripheral wall for adhering, growing and proliferating quickly. The proliferated cells further stretch out of the pore units and channels so that the cells are continuously attached to adjacent pore units and channels, and then the cells link together to combine with the implant in a short time. The entire implant is allowed to be wrapped by the linked cells and held in position. Therefore, the combination between the implant and the target part is enhanced to prevent the loosening of the implant and shorten the convalescence period of the tissue of the target part.

Preferably, in one preferred embodiment, only the shank surface is provided with the channels. In other preferred embodiment, not only the shank surface but also the thread surface of partial or all threads of the threaded portion can be provided with the channels.

Preferably, the threaded portion includes at least two thread sections, each of which defines a thread pitch formed between adjacent threads of the corresponding thread section. Respective thread pitches of the thread sections are different from each other. Furthermore, a second maximum outer diameter of the second end can be larger than a first maximum outer diameter of the first end to facilitate a rapid drilling action.

Preferably, each channel has a maximum vertical depth defined from one of the two second horizontal lines of the adjacent surface portions to the first horizontal line. The selected second horizontal line is in the top or highest position. The maximum vertical depth does not exceed 35 μm.

Preferably, the maximum width defined between the two junctions where one surface portion meets adjacent peripheral walls is not more than 15 μm, and the maximum width of the crest of the surface portion is not more than 5 μm.

Preferably, a central line is defined by passing a center between the adjacent channels and is perpendicular to the first horizontal line to thereby divide each surface portion into a first surface region and a second surface region. An area of the first surface region is different from an area of the second surface region, and thus the surface portion is asymmetrically formed.

Preferably, the pore units are joined in a lateral row to form a laterally-communicating and independent channel. Alternatively, the pore units are axially joined to form a longitudinal and independent channel. Alternatively, the end edges are joined in both directions to allow adjacent channels to communicate with each other, thereby defining mutual communication between the channels.

### BRIEF DESCRIPTION OF THE DRAWINGS

FIG. 1 is a schematic view showing a variation of a first preferred embodiment of this invention;

FIG. 2 is a schematic view showing a further variation of the first preferred embodiment of this invention;

FIG. 3 is a schematic view showing a further variation of the first preferred embodiment of this invention;

FIGS. 4A to 4C are plan and enlarged views of the encircled part in FIGS. 1 to 3 for showing communicating arrangements of the channels caused by rows of communicating pore units in different directions;

FIG. 5 shows an image of the channels according to the first preferred embodiment of this invention taken by SEM at a magnification of 1000 times, i.e. at 1000× magnification;

FIG. 6 shows an image of the channels in cross section taken by SEM at a magnification of 100 times, i.e. at 100× magnification, and taken along the A-A line of FIG. 5;

FIGS. 7A and 7E show images of the pore unit according to the first preferred embodiment of this invention taken by SEM at a magnification of 5000 times, i.e. at 5000× magnification; and

FIG. 8 is a schematic view showing the implant device of this invention applied to the dental implanting surgery.

### DETAILED DESCRIPTION OF THE PREFERRED EMBODIMENTS

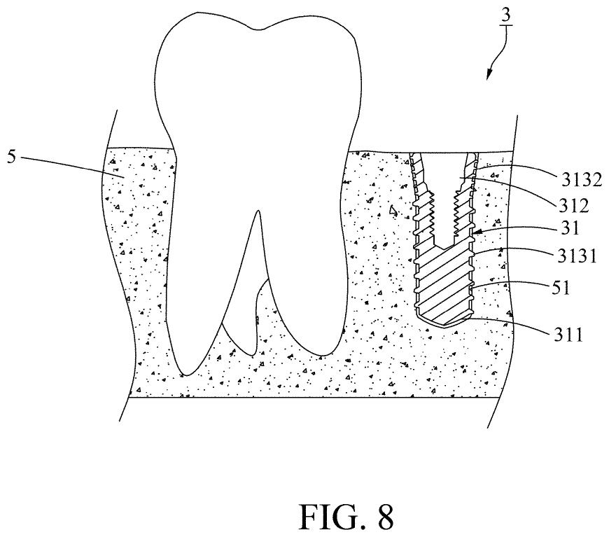

An implant device 3 of this invention is mainly applied to medical implanting field and adapted to be fastened to a target part where the proliferation of cells is required in the field of dentistry, orthopedics and the like. For example, it may serve as an artificial implant implanted into an alveolar bone of the oral cavity. It may serve as a fixture like an artificial screw used in the orthopedic surgery. In preferred embodiments, it is taken as an example in FIG. 8 that the target part is the alveolar bone in the oral cavity, and the implant device 3 is a root implant implanted into the alveolar bone 5.

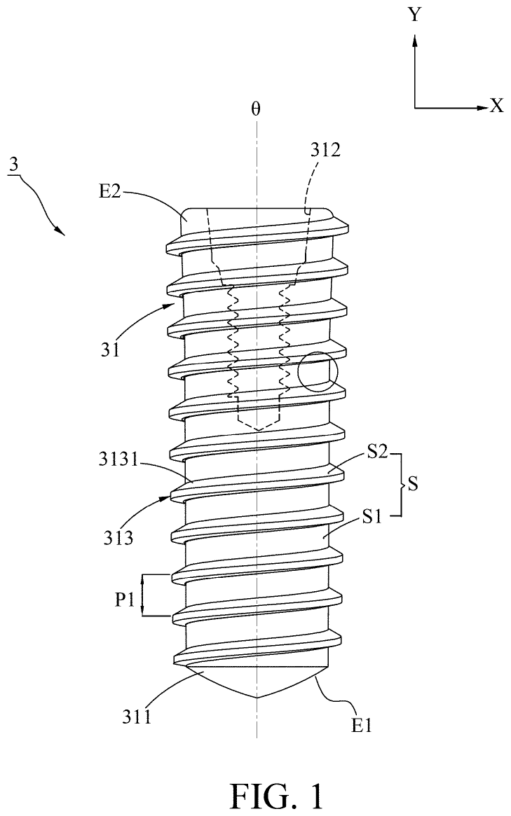

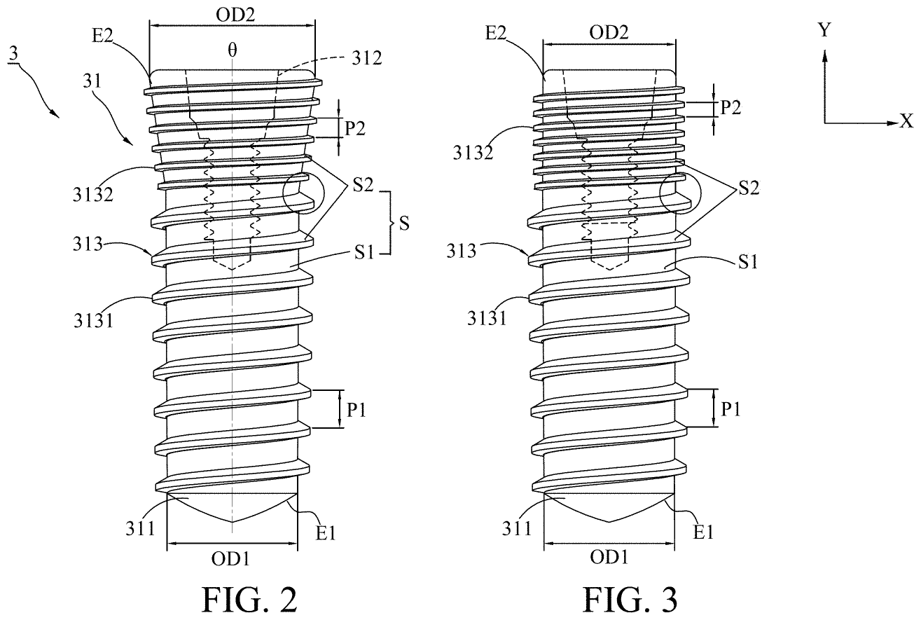

Referring to FIG. 1, an implant device 3 of, this invention includes an implant 31, a drilling portion 311, and a positioning hole 312. Specifically, the implant 31 defines a first end E1 and a second end E2 opposite to the first end E1 and defines a central axis θ. The drilling portion 311 is disposed at the first end E1. The positioning hole 312 is formed at the second end E2. The implant 31 further includes a threaded portion 313 spirally disposed between the two ends E1, E2. The threaded portion 313 can include a single-convoluted thread section 3131 extending from the first end E1 to the second end E2 and defining a thread pitch P1 between every two adjacent threads of the thread section 3131 (shown in FIG. 1). Alternatively, the threaded portion 313 includes at least two thread sections 3131, 3132 (shown in FIGS. 2 and 3), and two thread sections are taken as an example in the preferred embodiments. As shown in the figures, a first thread section 3131 spirally extends from the first end E1, and a second thread section 3132 extends from the first thread section 3131 to the second end E2. A thread pitch P1 is defined between every two adjacent threads of the thread section 3131. Between every two adjacent threads of the second thread section 3132 is defined a thread pitch P2 which can be different from the thread pitch P1, and herein the thread pitch P1 of the first thread section 3131 is preferably larger than the thread pitch P2 of the second thread section 3132. Furthermore, the second end E2 has a second maximum outer diameter OD2 equal to a first maximum outer diameter OD1 of the first end E1 (FIG. 3) or larger than (FIG. 2) the first maximum outer diameter OD1. When the outer diameter OD2 is larger than the outer diameter OD1, the diameter of the part of the implant 31 where the second thread section 3132 is located increases progressively to allow the corresponding thread diameter of the second thread section 3132 to increase gradually in a direction opposite to the drilling portion 311. This helps a rapid and stable fastening effect.

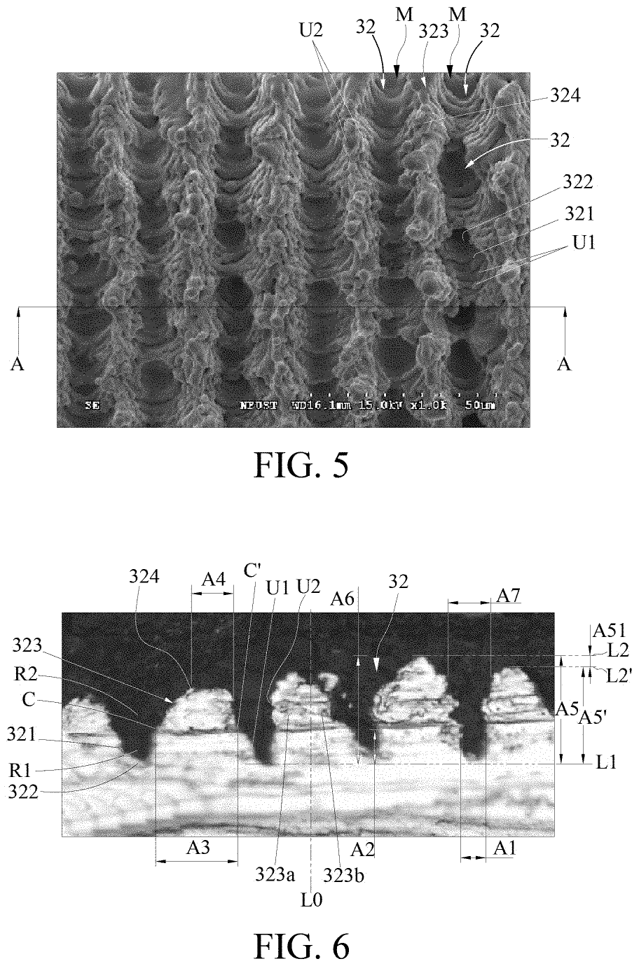

The implant 31 has an outer surface S exposed to an outside. There are channels M recessedly formed on the outer surface S. As shown in FIG. 5, each channel M includes a plurality of pore units 32. The pore units 32 are jointed one another in a row for defining each channel M. The outer surface S includes any exposed surfaces of the implant 31. It is possible that the surface portion S includes a shank surface S1, a surface extending axially from the first end E1, to the second end E2. Every two adjacent threads of the threaded portion 313 are axially spaced apart to expose the shank surface S1. It is also possible that the surface portion S includes the shank surface S1 and a thread surface S2 of all or partial threads of the threaded portion 313. Accordingly, partial or all exposed parts of the implant 31 can be provided with the channels M. For example, regarding a single convolution shown in FIG. 1, only the shank surface S1 is provided with the channels M. Alternatively, the shank surface S1 and any thread surface S2 of the threads of the thread section 3131, such as an upper flank face, a lower flank face and both flank faces, are provided with the channels M.

Regarding two convolutions shown in FIGS. 2 and 3, only the shank surface S1 is provided with the channels M. It is also possible that the shank surface S1 and any thread surface S2 of the threads of the thread section 3131 are provided with the channels M. Alternatively, the shank surface S1 and any thread surface S2 of the threads of the thread sections 3131, 3132, such as an upper flank face, a lower flank face and both flank faces, are provided with the channels M.

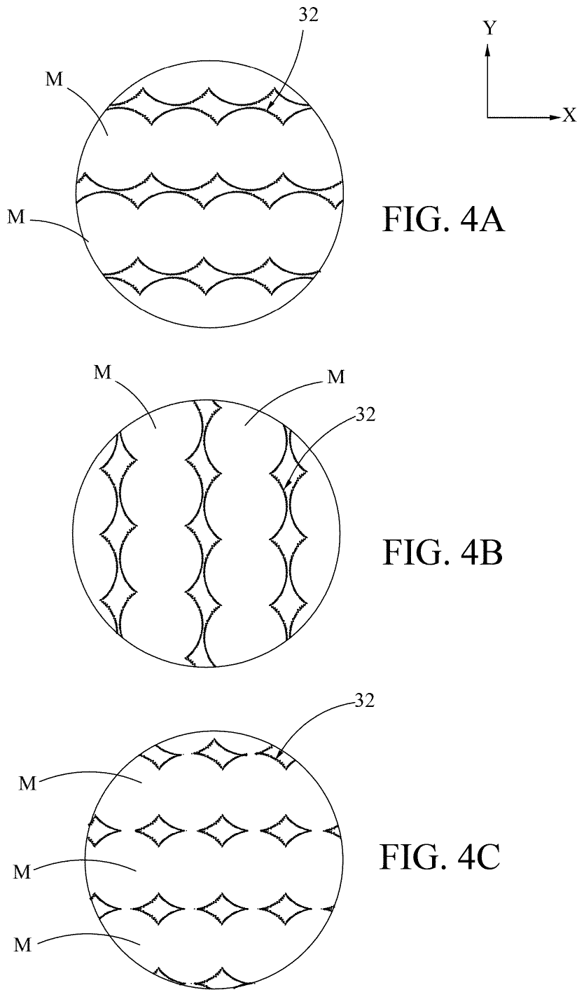

The joining direction of the pore units 32 decides the communicating arrangement of each channel M. For example, the pore units 32 are joined around the outer surface S in a lateral direction X, so the channels M each are independently formed and define the lateral communication shown in FIG. 4A. Alternatively, the pore units 32 are joined in a longitudinal direction, i.e. an axial direction Y, so the channels 32 each are independently formed and define the longitudinal communication shown in FIG. 4B. Alternatively, the pore units 32 are joined in both directions X, Y to interlink adjacent channels M, thereby defining the mutual communication shown in FIG. 4C. The three communicating types allow cells to be evenly and regularly distributed during the process of adhesion and proliferation and assist the cells in linking together to wrap and fix the entire implant 31 firmly. The communicating types attain the same effect which will be described in a later paragraph. FIGS. 4A to 4C are briefly shown to present different communicating types of the channels M but fail to show the detail of the interior of the channels M. FIGS. 5 to 7B are shown to present the interior of the channels M and will be described in later paragraphs.

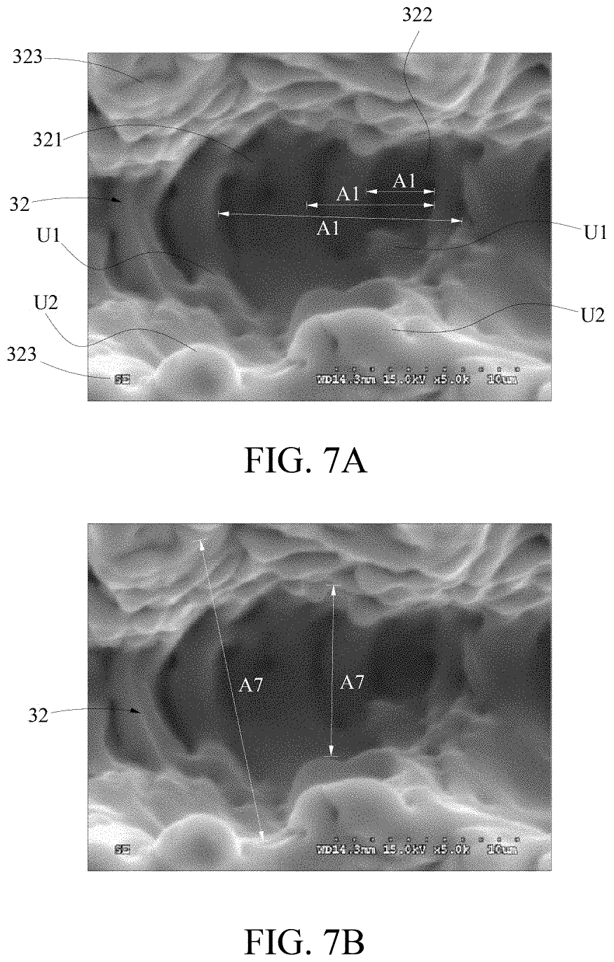

Referring to FIGS. 2, 5 and 6, an interior of each pore unit 32 includes a first area R1 and a second area R2 communicating with the first area R1. Specifically, the pore unit 32 includes a peripheral wall 321, a wall extending toward an interior of the implant 31. For example, when the pore unit 32 is recessedly provided on the shank surface S1, the peripheral wall 321 extends towards the central axis θ. Furthermore, the peripheral wall 321 is closed at the bottom to define a closed bottom portion 322, and the first area R1 is enclosed by the peripheral wall 321. The peripheral wall 321 also has a plurality of first projecting units U1 formed thereon, so the peripheral wall 321 is unevenly formed by having a wall surface with concavities and convexities. In short, the wall surface of the peripheral wall 321 is not smooth. Meanwhile, the peripheral wall 321 defines a first hole diameter A1 in the first area R1, and the first hole diameter A1 decreases gradually towards the bottom portion 322 as shown in FIG. 7A in which the first hole diameter A1 close to the bottom portion 322 is smaller than the first hole diameter A1 far from the bottom portion 322. Thus, the first area R1 of the pore unit 32 is relatively wide at its upper side and relatively narrow at its lower side. In this preferred embodiment, the first hole diameter A1 is not more than 10 μm, i.e. is equal to or less than 10 μm. Adjacent peripheral walls 321 of adjacent pore units 32 are joined to each other, which allows interiors of the first areas R1 to be in open communication with one anther in a row to thereby define each of the channels M.

The peripheral wall 321 extends to the bottom portion 322, and the extension of the peripheral wall 321 defines a first depth A2. Respective first depth A2 of the pore units 32 are substantially the same. A first horizontal line L1 is defined by passing the bottom portion 322, and preferably the first horizontal line L1 passes the lowest point of the bottom portion 322. Accordingly, the first horizontal lines L1 of the pore unit 32 are substantially in the same position so that the pore units 32 share the same first horizontal line L1. The first depth A2 is a vertical depth perpendicular to the first horizontal line L1. The first depth A2 does not exceed 10 μm. In other words, the first depth A2 is equal to or less than 10 μm for providing an optimum wall depth which helps the adhesion of cells.

In addition, the pore unit 32 includes a plurality of second projecting units U2 extending outwards from the peripheral wall 321. The second projecting units U2 extend in a direction opposite to the bottom portion 322 and overlap one another. The overlapped second projecting units U2 are crowded between every two adjacent channels to define a surface portion 323, and a surface of the surface portion 323 is not smooth because of the overlapping arrangement. The surface portion 323 has a crest 324. When the overlapping of the second projecting units U2 extends in the direction opposite to the first area R1, the terminal of the overlapping at the highest spot is defined as the crest 324. The second area R2 is defined between every two adjacent surface portions 323 and is in communication with the first area R1. Thus, the interior of the pore unit 32 includes communicating first and second areas R1, R2. A maximum width A3 is defined between two junctions C1, C1′ where each surface portion 323 meets the peripheral walls 321 of the channels M adjacent to the surface portion 323. Preferably, the maximum width A3 is not more than 15 μm, i.e. is equal to or less than 15 μm. The crest 324 defines a maximum width A4, and preferably the maximum width A4 is not more than 5 μm, i.e. is equal to or less than 5 μm. When the maximum width A3 is larger than the maximum width A4, a space A7 defined between every two adjacent surface portions 323 can increase gradually towards the crest 324, as shown in FIGS. 6 and 7B where the second area R2 may be relatively wide at its upper side and relatively narrow at its lower side. The space A7 is not more than 30 μm, i.e. is equal to or less than 30 μm.

In the preferred embodiment, the surface portion 323 is asymmetric. A center between every two adjacent channels M defines a central line L0 perpendicular to the first horizontal line L1 for dividing the surface portion 323 into a first surface region 323a and a second surface region 323b. An area of the first surface region 323a is different from an area of the second surface region 323b, so the whole surface portion 323 is asymmetrically formed, which allows the center of the crest 324 to deviate from the central line L0. Two second horizontal lines L2, L2′ are respectively defined by passing the crests 324 of the adjacent surface portions 323, and two vertical distances A5, A5′ are defined. The vertical distance A5 is defined between the corresponding second horizontal line L2 and the first horizontal line L1. The vertical distance A5′ is defined between the corresponding second horizontal line L2′ and the first horizontal line L1. A difference A51 of the vertical distances A5, A5′ is not more than 5 μm, i.e. is equal to or less than 5 μm. Accordingly, adjacent crests 324 are in different positions to allow the adjacent surface portions 323 to have different heights when the difference A51 is not equal to zero. Alternatively, the adjacent crests 324 are substantially equal in position to allow the adjacent surface portions 323 to have the same height when the difference A51 is equal to zero. In the preferred embodiment, it is taken as an example that the second horizontal lines L2, L2′ are parallel to each other to present the crests 324 in different positions.

An interior of each channel M includes communicating first areas R1 and communicating second areas R2 which communicate with the communicating first areas R1. The channel M has a maximum vertical depth A6 defined from one of the second horizontal lines L2, L2′ of adjacent surface portions 323 to the first horizontal line L1, and the selected second horizontal line is in a top or highest position, as for example shown in FIG. 6 where the line L2 is higher than the line L2′ to define the maximum vertical depth A6. Preferably, the maximum vertical depth A6 does not exceed than 35 μm. The maximum vertical depth A6 can be equal to or less than 35 μm to provide an optimum whole channel depth which facilitates the adhesion of cells.

The operation is described with the aid of FIG. 8 where the implant device 3 shown in FIG. 2 is taken as an example and is used as a fixture implanted into an alveolar bone 5 in the oral cavity. To start an implanting operation, a surgical tool (not shown) is inserted into the positioning hole 312 and rotates to screw the threaded portion 313 into a predrilled hole 51 of the alveolar bone 5 and fasten the implant 31 in position. Because two thread sections 3131, 3132 are provided, the first thread section 3131 with the larger pitch P1 has a large contact area to cut an inner wall of the hole 51 and screw into the hole 51. The second thread section 3132 with a smaller pitch P2 follows the screwing tracks of the first thread section 3131 to continue the cutting and screwing action. This design attains a quick fastening action, helps relieve discomfort of patients during the implanting operation, and attains a stable positioning effect.

After the implant 31 is implanted into the alveolar bone 5, bone cells (not shown) are derived from the bone 5 during the process of convalescing. The surface portions 323 each have an uneven surface because of the overlapped second projecting units U2, and the interior of the second area R2 is wide at its upper side, so the bone cells grip the surface portions 323 quickly and smoothly for executing the adhesion and proliferation in respective channels M and between adjacent channels M. In other words, the bone cells go into the first area. R1 along the second projecting units U2 of the surface portions 323 and then travel along the peripheral wall 321 toward the bottom portion 322 so that the bone cells are attached to each pore unit 32. The surface of each peripheral wall 321 is not smooth because of the first projecting units U1, and the interior of the first area R1 is wide at its upper side, so the bone cells are quickly adhered to the peripheral wall 321 of each channel M for executing the cell proliferation as a result of cell growth and cell division. Because the pore units 32 are in open communication one another to form each channel M, the proliferated cells climb and stretch along the adjacent peripheral walls 322 of the channel M continuously and distribute over each channel M. Then, the bone cells project from the respective channels M and pore units 32 and grow along the surface portions 323 like a creeping or climbing plant to attach other channels M and pore units 32 for adhesion. Finally, the bone cells link with each other and wrap the entire implant 31 to fix the implant 31 to the alveolar bone 5 firmly and prevent the implant 31 from loosening. Thus, a firm combination between the implant 31 and the alveolar bone 5 is attained to enhance the osseointegration between the implant 31 and the alveolar bone 5.

It is noted that the peripheral walls 321 of the pore units 32 are substantially equal in the first depth A2, and each surface portion 323 is asymmetrically formed. Therefore, each channel M provides the optimum depth for adhesion of the cells, and the adhesion of the cells are distributed in a direction corresponding to the asymmetrical arrangement to thereby help the cell proliferation and cell division. It is also noted that the adjacent crests 324 can be in different positions to provide adjacent channels M with different maximum vertical depths A6. This condition allows the cells to grip the second projecting units U2 and further creep between adjacent surface portions 323 quickly and firmly, thereby linking the cells to each other between the pore units 32 and channels M. Thus, the configuration which includes the channel M formed by communicating pore units 32, the uneven peripheral wall 321, and the surface portion 323 defined by the overlapping condition allows the cells to be smoothly and quickly attached to the peripheral walls 321 and the surface portions 323 of the pore units 32 to increase the initial adhesion and growth of the cells. The cells are continuously adhered to the channels M for growing, stretching and distributing quickly and evenly. The inner communicating space of the channel M provides a wide contact area for the adherence and growth of osteocytes. In other words, the contact surface area between the implant 31 and the cells increases, so the cell adhesion and growth ability can be efficiently promoted to assist the cells in executing the rapid and smooth adhesion, proliferation and close linking action. According to the above arrangement, the effect of osseointegration is enhanced to speed up the process of healing the osseous tissue of the alveolar bone, which helps shorten the convalescence period.

Tables 1 to 3 show respective values of the dental implant stability quotient (ISQ) of a human trial at different stages, e.g. during the first week (hereinafter referred to as “Week 1”), the eighth week (hereinafter referred to as “Week 8”), and the sixteenth week (hereinafter referred to as “Week 16”) after the implant of this invention is implanted into the alveolar bone. ISQ is a value on a scale which indicates the level of stability and osseointegration in dental implants and is measured by an implant stability meter. The result of the trial shows that the mean of the initial ISQ of Week 1 is 67.9 (±8.4), and the values of the ISQ of Week 8 and Week 16 are larger than 60, with the mean of 71.4 (±6.3) at Week 8 and the mean of 74.4 (±8.1) at Week 16. The ISQ increases 5% and 9% at Week 8 and Week 16 in comparison with that of Week 1. Higher values of ISQ indicate greater stability, which shows that the osseointegration effect after the implantation can be enhanced to shorten the convalescence period. Therefore, every subject of the trial has reached the implant success criteria.

TABLE 1
ISQ and Subject Demographics Analysis (Week 1)

| | | | Standard | | | | | Degree of |
|---|---|---|---|---|---|---|---|---|
| | Number | Average | deviation | Median | (Q1, Q3) | T-Value | P-Value | Freedom |
| Sex | | | | | | | | |
| Female | 28 | 66.36 | 5.71 | 68 | (61.50, 71.25) | −0.43 | 0.66 | 68 |
| Male | 32 | 68.90 | 9.57 | 70 | (63.75, 77.25) | | | |
| Total | 60 | 67.95 | 8.36 | 68.5 | (63.75, 74.50) | | | |
| Age | | | | | | | | |
| 20-45 years | 27 | 65.15 | 12.86 | 67.5 | (63.75, 74.50) | −0.48 | 0.63 | 40 |
| Over 46 years | 33 | 68.56 | 8.52 | 69.75 | (61.25, 75.25) | | | |
| Total | 60 | | | | | | | |

TABLE 2
ISQ and Subject Demographics Analysis (Week 8)

| | | | Standard | | | | | Degree of |
|---|---|---|---|---|---|---|---|---|
| | Number | Average | deviation | Median | (Q1, Q3) | T-Value | P-Value | Freedom |
| Sex | | | | | | | | |
| Female | 28 | 70.77 | 6.25 | 72 | (68.50, 72.65) | −0.50 | 0.62 | 33 |
| Male | 32 | 71.87 | 6.53 | 73.5 | (69.00, 76.00) | | | |
| Total | 60 | | | | | | | |
| Age | | | | | | | | |
| 20-45 years | 27 | 74.00 | 4.31 | 73 | (71.25, 78.63) | 1.91 | 0.06 | 33 |
| Over 46 years | 33 | 69.91 | 6.94 | 71.75 | (65.75, 75.63) | | | |
| Total | 60 | | | | | | | |

TABLE 3
ISQ and Subject Demographics Analysis (Week 16)

| | | | Standard | | | | | Degree of |
|---|---|---|---|---|---|---|---|---|
| | Number | Average | deviation | Median | (Q1, Q3) | T-Value | P-Value | Freedom |
| Sex | | | | | | | | |
| Female | 28 | 76.59 | 8.73 | 76.75 | (68.88, 84.00) | 1.38 | 0.18 | 30 |
| Male | 32 | 72.68 | 7.29 | 73 | (68.13, 76.38) | | | |
| Total | 60 | | | | | | | |
| Age | | | | | | | | |
| 20-45 years | 27 | 71.31 | 7.17 | 73 | (66.25, 73.75) | −2.04 | 0.05 | 31 |
| Over 46 years | 33 | 76.98 | 5.54 | 76.75 | (70.75, 86.00) | | | |
| Total | 60 | | | | | | | |

To sum up, this invention mainly includes a plurality of channels recessedly formed on the outer surface of the implant. Each of the channels includes a plurality of pore units joined to each other in a row, and a multiplicity of rows of the communicating pore units defines the plurality of channels. Accordingly, cells obtained from the target part where the implant is fastened are smoothly attached to the surface portions formed by overlapping second projecting units between adjacent channels and are quickly attached to the uneven peripheral walls of the pore units for attaining quick adhesion, distribution and proliferation in each channel. Proliferated cells link with each other between adjacent channels. Accordingly, the cells are adhered to the implant in a short period of time, and the entire implant is wrapped by the cells and firmly held in position to increase the combination between the implant and the target part. Therefore, the loosening of the implant is prevented, and the target part heals up quickly.

While the embodiments of this invention are shown and described, it is understood that further variations and modifications may be made without departing from the scope of this invention.

What is claimed is:

1. An implant device comprising an implant having opposite first and second ends, said implant including an outer surface exposed to an outside, said implant including a drilling portion disposed at said first end, a positioning hole formed at said second end, and a threaded portion spirally disposed between said first end and said second end;
wherein a plurality of channels are recessedly formed on said outer surface of said implant, said outer surface including at least a shank surface extending from said first end to said second end, said shank surface being exposed to the outside when adjacent threads of said threaded portion are axially spaced apart, each of said plurality of channels including a plurality of pore units jointed to each other, and an interior of said plurality of pore units thereby being in open communication with one another in a row to thereby define each of said plurality of channels, the interior of each of said plurality of pore units including a first area and a second area communicating with said first area;
each of said plurality of pore units having a peripheral wall extending toward an interior of said implant and forming a closed bottom portion and a plurality of second projecting units extending outwards from said peripheral wall, said first area being enclosed by said peripheral wall, the extension of said peripheral wall defining a first depth perpendicular to a first horizontal line, said first depth being not more than 10 μm, said first horizontal line being defined by passing said bottom portion, said peripheral wall having a plurality of first projecting units formed thereon, and said peripheral wall thereby being formed in a surface with concavities and convexities and defining a first hole diameter within said first area, said first hole diameter decreasing gradually towards said bottom portion and being not more than 10 μm; and
said plurality of second projecting units extending in a direction opposite to said bottom portion and overlapping one another between every two adjacent channels to thereby define a surface portion with a crest, said second area being defined between every two adjacent surface portions, each said surface portion being asymmetric, a maximum width defined between two junctions where each said surface portion meets said peripheral walls of said every two adjacent channels being larger than a maximum width of said crest of each said surface portion, a space being defined between said every two adjacent surface portions and increasing gradually toward said crest, said space being not more than 30 μm, two second horizontal lines being respectively defined by passing said crests of said every two adjacent surface portions, two vertical distances each being defined between the corresponding second horizontal line and said first horizontal line, and a difference of said two vertical distances being not more than 5 μm.

2. The implant device according to claim 1, wherein said outer surface includes a thread surface of said threads of said threaded portion.

3. The implant device according to claim 1, wherein said threaded portion includes at least two thread sections, a thread pitch being formed between adjacent threads of the corresponding thread section, respective thread pitches of said at least two thread sections being different from each other.

4. The implant device according to claim 2, wherein said threaded portion includes at least two thread sections, a thread pitch being formed between adjacent threads of the corresponding thread section, respective thread pitches of said at least two thread sections being different from each other.

5. The implant device according to claim 3, wherein said second end has a second maximum outer diameter larger than a first maximum outer diameter of said first end.

6. The implant device according to claim 4, wherein said second end has a second maximum outer diameter larger than a first maximum outer diameter of said first end.

7. The implant device according to claim 1, wherein each of said plurality of channels has a maximum vertical depth defined from one of said two second horizontal lines to said first horizontal line, with said selected one second horizontal line located in a highest position, said maximum vertical depth being not more than 35 μm.

8. The implant device according to claim 1, wherein said maximum width defined between said two junctions is not more than 15 μm, and said maximum width of said crest of each said surface portion is not more than 5 μm.

9. The implant device according to claim 1, wherein said plurality of said pore units are joined in a lateral direction, and each of said plurality of channels thereby is independently formed and defines lateral communication.

10. The implant device according to claim 1 wherein said plurality of said pore units are joined in a longitudinal direction, and each of said plurality of channels thereby is independently formed and defines longitudinal communication.

11. The implant device according to claim 1, wherein said plurality of said pore units are laterally and longitudinally joined to interlink adjacent channels and thereby define a mutual communication.

12. The implant device according to claim 1, wherein a center between said every two adjacent channels defines a central line perpendicular to the first horizontal line for dividing each said surface portion into a first surface region and a second surface region, an area of said first surface region being different from an, area of said second surface region, and each said surface portion thereby being asymmetrically formed.
